(19) United States
(12) Patent Application Publication
(10) Pub. No.: US 2004/0128885 A1
(43) Pub. Date: Jul. 8, 2004

(54) Curb address banner

(76) Inventor: Monte L. Evans, Baytown, TX (US)

Correspondence Address: Steven S. Newsom, P.O. Box 33, Barker, TX, 77413-0033, US

(21) Appl. No.: 10/336,600

(22) Filed: Jan. 3, 2003

(51) Int. Cl. G09F 7/12; G09F 19/00

(52) U.S. Cl. 40/594; 40/615

(57) ABSTRACT

A durable, long lasting, highly visible Curb Banner is provided that makes the address of a property easy to see and also allows a user to display graphics such as pictures or illustrations on their curb. One embodiment of the invention provides for an easy method of changing the graphics.

### CROSS REFERENCES TO RELATED APPLICATIONS

None.

### BACKGROUND

1. Field of Invention

This invention relates to curb banners, specifically reflective curb banners and changeable curb banners.

2. Description of Prior Art

Property owners currently use a number of different methods to indicate their addresses. One common method is to place identifying numbers on a building or on some other structure such as a mailbox. Another common method is to paint the property address numbers on the property's street curb. However, these methods have serious drawbacks. Firefighters, police and other emergency personnel have recognized that many of the address numbers on buildings or other structures can often be difficult to locate and read, especially at night. Address numbers are often painted on a property's curb. However, painted curb numbers will quickly fade or cannot be seen well at night. In an emergency it is critical that emergency personnel are able to quickly identify the property address. These methods often do not adequately identify a property for emergency personnel. Another drawback with the traditional methods of indicating a property's address is that it is difficult or costly to provide aesthetically pleasing graphics with the identifying address numbers or graphics that can be easily changed.

### OBJECTS AND ADVANTAGES

Accordingly, several objects and advantages of the present invention are to provide an economical, long lasting and highly visible address banner that can easily be affixed to a property's curb. The highly reflective nature and the bold colors possible with the Curb Banner will allow emergency personnel to easily and quickly determine a property's address, even at night in low light conditions. Painting address numbers on a curb will wear out and fade relatively quickly where the Curb Banner will maintain the quality and reflectivity of its graphics and thus its visibility and attractiveness for several years. The present invention also allows a user to easily display high quality and long lasting graphics, such as logos or holiday symbols, on their curb.

In addition, one embodiment of the invention will allow the user to easily change the Curb Banner whenever they want. For example, the user may have one Curb Banner that carries the logo of their favorite football team that they display during football season and another with the logo of their favorite hockey team that they display during hockey season. Or they may simply want a different Curb Banner for each holiday that they observe.

Still further objects and advantages will become apparent from a consideration of the ensuing description and accompanying drawings.

### BRIEF DESCRIPTION OF THE DRAWINGS

FIG. 1 is a side view of the Curb Banner showing the different layers of the laminate.

FIG. 2 is a top view of the Graphics Sheet Top Surface with the Graphic printed on it.

FIG. 3 is a side view of the Graphics Laminate showing the different layers of the Graphics Laminate.

FIG. 4 is a top view of the Graphics Sheet Top Surface with the Graphic printed on it.

FIG. 5 is a side view of the Base Laminate showing the different layers of the Base Laminate.

### Reference Numerals

10 Graphics Sheet

11 Graphics Sheet Bottom Surface

12 Graphics Sheet Top Surface

13 Graphic

14 Overlaminate

16 Adhesive

18 Graphics Laminate

20 Base Laminate

22 Magnet

24 Magnet Top Surface

26 Magnet Bottom Surface

28 Metal Sheet

30 Metal Sheet Top Surface

32 Metal Sheet Bottom Surface

### SUMMARY

A Curb Banner is provided that serves two important functions. First, it provides a durable, long lasting and highly visible indicator of a property address. Because the Curb Banner is made with highly reflective material it can easily be seen, even at night in very low light conditions. This can be critical in order to allow emergency personnel to locate a property quickly if needed. The second function is to allow property owners to display high quality and long lasting pictures or illustrations, such as team logos or holiday symbols, on their curb. A second embodiment of the invention allows the user to easily change the graphics at will.

### PREFERRED EMBODIMENT—DESCRIPTION

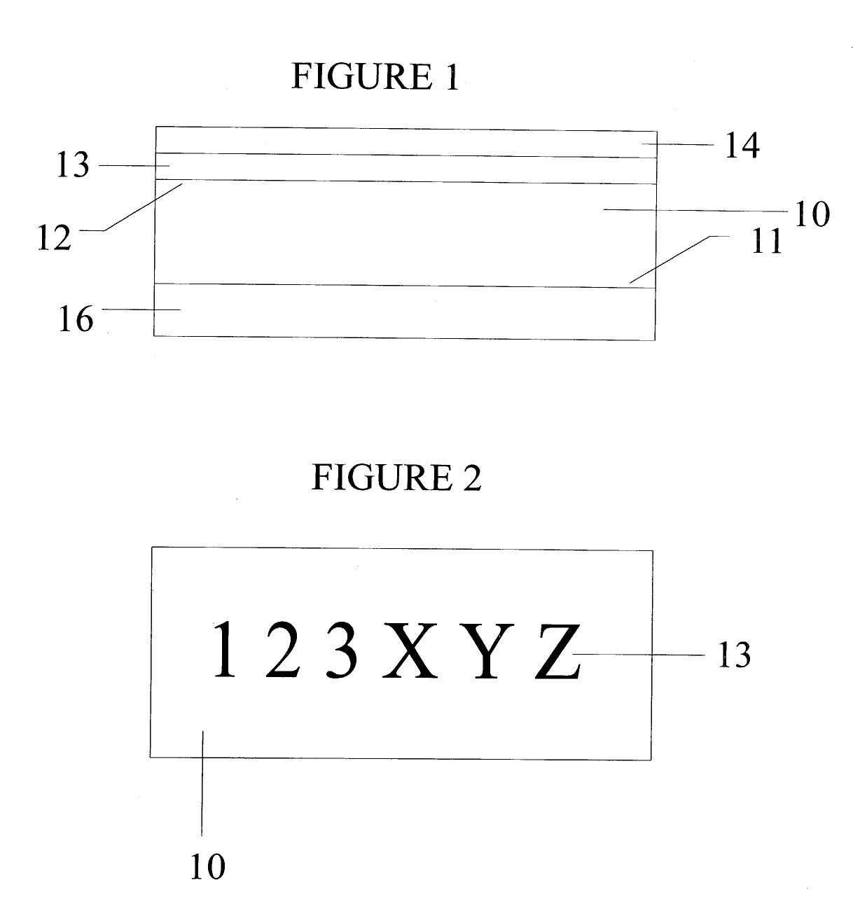

The preferred embodiment of the Curb Banner is as a laminate made up of 4 elements bonded together. As can be seen in FIG. 1, one element of the laminate is a Graphics Sheet 10. A second element is a Graphic 13 which may include the property address alone or the property address with drawings, illustrations or pictures. The Graphic 13 may also simply be a drawing, illustration or picture without the property address. As can be seen in FIG. 2, the Graphic 13 is printed on the Graphics Sheet Top Surface 12. The Graphic 13 is preferably printed using a reflective paint. Preferably, the Graphics Sheet 10 is made out of a highly reflective prismatic vinyl material. However, the Graphics Sheet 10 may be manufactured out of other suitable material. As can be seen in FIG. 1, a clear protective Overlaminate 14 is applied over the Graphics Sheet Top Surface 12 and the Graphic 13 and a self-stick Adhesive 16, suitable for bonding to a curb, is bonded to the Graphics Sheet Bottom Surface 11. The Overlaminate 14 is a clear, flexible material that will protect the Graphics Sheet 10 from physical damage as well as damage from ultra-violet radiation.

### PREFERRED EMBODIMENT—OPERATION

The operation of the preferred embodiment is very simple. The Curb Banner is simply placed with the Adhesive 16 against the curb and it is pressed into place. The Adhesive 16 will then hold the Curb Banner in place. It is desirable that the curb first be dry and clean to insure good adhesion. In order to improve adhesion, a primer may first be applied to the curb.

### OTHER EMBODIMENTS

Changeable Curb Banner—Description

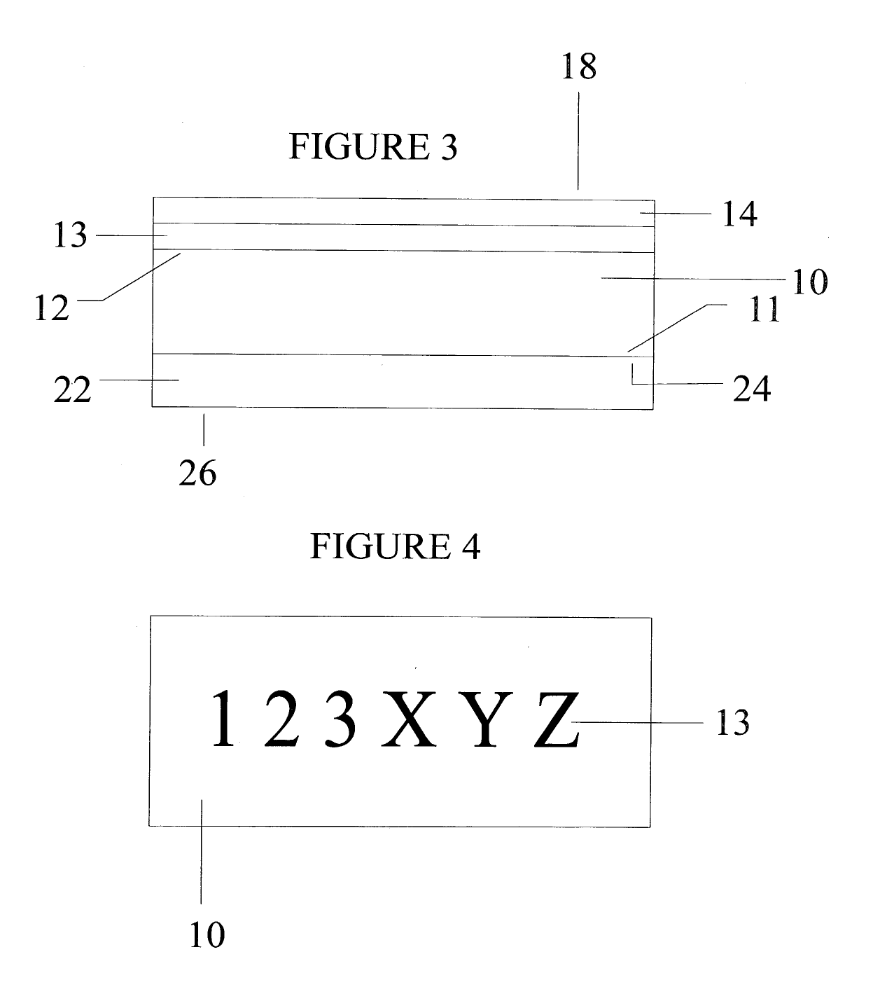

A second embodiment of the invention provides for the ability to change the Curb Banner. This embodiment consists of two laminates, a Graphics Laminate 18 and a Base Laminate 20. As can be seen in FIG. 3, the Graphics Laminate 18 is comprised of four elements, a Graphics Sheet 10 having a Graphics Sheet Bottom Surface 11 and a Graphics Sheet Top Surface 12, a Graphic 13, an Overlaminate 14 and a Magnet 22 having a Magnet Top Surface 24 and a Magnet Bottom Surface 26. The Graphic 13 is the address numbers and illustrations or pictures that the user wants to display. As can be seen in FIG. 4, the Graphic 13 is printed on the Graphics Sheet Top Surface 12. It is preferred that the Graphic 13 be printed using reflective paint. The Graphics Sheet 10 is made out of a highly reflective prismatic vinyl material. However, the Graphics Sheet 10 may be manufactured out of other suitable material. The Overlaminate 14 is applied over the Graphic 13 and the Graphics Sheet Top Surface 12. The Overlaminate 14 is preferably a clear, flexible material that will protect the Graphics Sheet 10 from physical damage as well as damage from ultra-violet radiation. As can be seen in FIG. 3, the Magnet Top Surface 24 is bonded to the Graphics Sheet Bottom Surface 11. The Magnet Bottom Surface 26 is the magnetized surface of the Magnet 22. The Magnet 22 is a flexible sheet magnet.

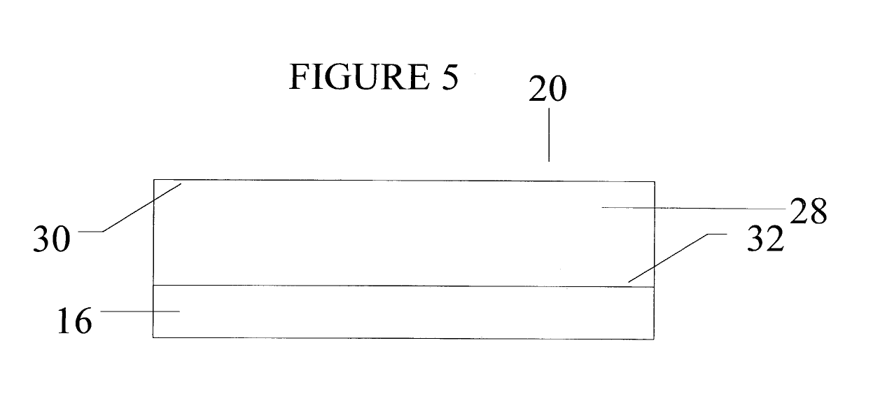

As can be seen in FIG. 5, the Base Laminate 20 is comprised of two elements, a Metal Sheet 28 and an Adhesive 16. The Metal Sheet 28 is flexible and has a Metal Sheet Top Surface 30 and a Metal Sheet Bottom Surface 32 and is made out of a material that a magnet will magnetically adhere to. For example, paper steel or thin sheet steel. The Adhesive 16 is a self-stick adhesive suitable for bonding to a curb. The Adhesive 16 is bonded to the Metal Sheet Bottom Surface 32.

Obviously the locations of the Magnet 22 in the Graphics Laminate 18 and the Metal Sheet 28 in the Base Laminate 20 could be reversed to achieve the same result.

Changeable Curb Banner—Operation

This embodiment of the invention is also very simple to use. The Adhesive 16 of the Base Laminate 20 is placed against the curb bonding the Base Laminate 20 to the curb. The Magnet Bottom Surface 26 of the Graphics Laminate 18 is placed onto the Metal Sheet Top Surface 30, magnetically bonding the Graphics Laminate 18 to the Base Laminate 20. When the user wants to change the graphics they simply peel the Graphics Laminate 18 off of the Base Laminate 20 and replace it with another graphics laminate that has different graphics printed on it.

### CONCLUSIONS, RAMIFICATIONS, AND SCOPE

Accordingly, it can be seen that the present invention provides a highly visible, long lasting and colorful means of providing property identification. The invention will also provide the property owner with the ability to display any additional graphic that they desire.

Although the description above contains many specificities, these should not be construed as limiting the scope of the invention but as merely providing illustrations of some of the presently preferred embodiments of this invention. Various other embodiments and ramifications are possible within it's scope. For example, although the figures herein show the invention as rectangular in shape, the invention may be made in any shape. Also, the graphics may be in any color or size and shape. Different materials may be used in the inventions manufacture. For example, if suitable materials can be found that exhibit the required durability and resistance to ultra-violet radiation then the Overlaminate 14 may not be necessary.

Thus the scope of the invention should be determined by the appended claims and their legal equivalents, rather than by the examples given.

What I claim is:

1. A curb banner for displaying graphics on a curb, comprising:
(a) a graphics sheet having a graphics sheet top surface and a graphics sheet bottom surface,
(b) a graphic printed onto said graphics sheet top surface,
(c) a clear overlaminate applied over said graphics top surface and said graphic, and
(d) a self-stick adhesive bonded to said graphics sheet bottom surface, said adhesive suitable for bonding to a curb.

2. The curb banner of claim 1 wherein said graphics sheet is made out of a reflective material.

3. The curb banner of claim 1 wherein said graphic is made out of a reflective material.

4. A curb banner for displaying graphics on a curb and allowing the graphics to be changed, comprising:
(a) a graphics laminate consisting of a graphics sheet having a graphics sheet top surface and a graphics sheet bottom surface, a graphic, a clear overlaminate and a magnet having a magnet top surface and a magnet bottom surface, said graphic printed onto said graphics sheet top surface, said overlaminate applied over said graphic and said graphics sheet top surface, said magnet top surface bonded to said graphics sheet bottom surface, said magnet bottom surface being said magnet's magnetized surface,
(b) a base laminate consisting of a flexible metal sheet having a metal sheet top surface and a metal sheet bottom surface, said metal sheet made out of a material that a magnet can magnetically bond to, and a self stick adhesive suitable for bonding to a curb bonded to said metal sheet bottom surface,
(c) said first graphics laminate removably magnetically bonded to said metal sheet top surface.

5. The curb banner of claim 4 wherein said graphics sheet is made out of a reflective material.

6. The curb banner of claim 4 wherein said graphic is made out of a reflective material.
